(19) United States
(12) Patent Application Publication
(10) Pub. No.: US 2012/0162091 A1
(43) Pub. Date: Jun. 28, 2012

(54) SYSTEM, METHOD, AND COMPUTER PROGRAM PRODUCT FOR MULTIDISPLAY DRAGGING

(76) Inventors: Kenton M. Lyons, Santa Clara, CA (US); Nirmal Patel, Mountain View, CA (US); Trevor Pering, San Francisco, CA (US); Roy Want, Los Altos, CA (US)

(21) Appl. No.: 12/977,939

(22) Filed: Dec. 23, 2010

(51) Int. Cl. G06F 3/041

(52) U.S. Cl. 345/173

(57) ABSTRACT

Methods and systems to allow users to gain the advantages of a large-format touch display by using smaller, cost-effective touch displays. Given two adjacent displays, regions may be created on both sides of the boundary between the displays. These regions may grow and shrink based on the user's movement, i.e., the velocity of a stylus or finger towards the boundary. If the user lifts his stylus within a region on one display, he may finish the tracking on the other by landing within the corresponding region of the latter display. This may allow a user to begin a drag on one display, drag towards another display, and “flyover” to the second display without slowing. The lift event may be removed when the first display detects the stylus being lifted as it moves towards the second. The landing on the second display may be removed.

### BACKGROUND

Touch-enabled platforms, such as tablets and mobile phones, are increasing in popularity. Given that it is common for a person to own a laptop computer, a tablet computer, and a smart phone, it is also common for a person to use two or more of these devices at the same time. It is easy to imagine the value of dynamically combining the resources of multiple devices. It would be useful, for example, to join the displays of two tablets placed side-by-side to act as one logical display. While such a system may provide a single logical display, it does not allow for seamless input across the devices. In particular, there is currently no mechanism available that would allow a user to start a pointing operation, such as a drag operation, on one device and then cross over to the second device to finish the drag. Lifting the user's finger or stylus off of the first device terminates any in-progress motion-based operation. Moreover, there is currently no way to determine whether the user, when he lifts his stylus, wishes to continue that drag operation on another device, or whether he wishes to end the input.

### BRIEF DESCRIPTION OF THE DRAWINGS/FIGURES

FIG. 1 is a diagram illustrating the operating environment of the system and process described herein, according to an embodiment.

FIG. 2 is a diagram illustrating the motion of a user input during usage of the system and process described herein, according to an embodiment.

FIG. 3 is a diagram illustrating the expansion and contraction of lift and landing zones, according to an embodiment.

FIG. 4 is a state diagram illustrating the system and process described herein, according to an embodiment.

FIGS. 5a and 5b are process flowcharts illustrating the process described herein, according to an embodiment.

FIG. 6 is a block diagram illustrating a software or firmware embodiment of the system and process described herein, along with a computing context, according to an embodiment.

In the drawings, the leftmost digit(s) of a reference number identifies the drawing in which the reference number first appears.

### DETAILED DESCRIPTION

An embodiment is now described with reference to the figures, where like reference numbers indicate identical or functionally similar elements. While specific configurations and arrangements are discussed, it should be understood that this is done for illustrative purposes only. A person skilled in the relevant art will recognize that other configurations and arrangements can be used without departing from the spirit and scope of the description. It will be apparent to a person skilled in the relevant art that this can also be employed in a variety of other systems and applications other than what is described herein.

Disclosed herein are methods and systems to allow users to gain the advantages of a large-format touch display by using smaller, more cost-effective touch displays. Given two adjacent displays, dynamic regions may be created on both sides of the boundary between the two component displays. These regions may grow and shrink dynamically based on the user's movement, i.e. the velocity of a stylus or finger towards the boundary. If the user lifts his stylus or finger within a region on one display, he may have the opportunity to finish the tracking action on the other display by landing within the corresponding region of the latter display. This may allow a user to begin a drag operation on one touch display, drag towards another touch display, and “flyover” to the second display without slowing down to complete the drag. The unwanted lift event may be removed when the first touch display detects the stylus or finger being lifted as it moves towards the second display. The landing event on the second display may also be removed.

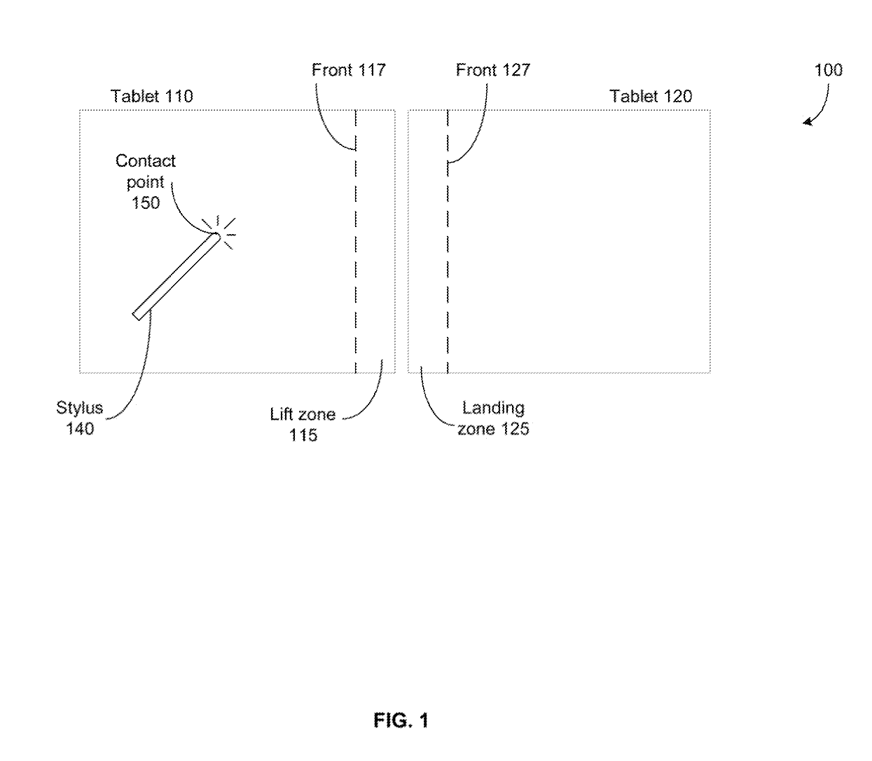

The system is illustrated in FIG. 1, according to an embodiment. The system may comprise two touch displays, shown here as tablets 110 and 120. Note that other embodiments may operate on computing platforms that may not be typically classified as tablets, such as smart phones, or any other computing systems that include touch-sensitive displays for user input. Interaction with the tablets may be performed by using a stylus 140. The point at which stylus 140 may make contact with the tablets is shown as contact point 150. Each tablet may include a dynamic region of the display that accommodates the processing described herein. On tablet 110, this region is shown as lift zone 115. The lift zone 115 may be oriented parallel to the edge adjacent to tablet 120. The boundary of lift zone 115 opposite the adjacent edge is shown as front 117. Tablet 120 may include a landing zone 125. Landing zone 125 may be oriented parallel to the edge adjacent to tablet 110. The boundary of landing zone 125 opposite the adjacent edge is shown as front 127.

Note that while interaction with the tablets 110 and 120 is shown in FIG. 1 using a stylus 140, in other embodiments, other input devices may be used. Moreover, in an alternative embodiment, the user's finger may be used to define contact point 150 and to perform drags, lifts, etc.

In addition, the terms “lift zone” and “landing zone” may be defined in terms of the tablet on which the user interaction begins. In FIG. 1, the user interaction may begin on tablet 110. so that an attempt to drag from tablet 110 to tablet 120 may include lifting the stylus 140 from lift zone 115, and making contact with tablet 120 in landing zone 125. If, on the other hand, the user interaction where to begin on tablet 120, such that the user wishes to perform a drag from tablet 120 to tablet 110, the zone adjacent to the left edge on tablet 120 would be the lift zone, while the zone adjacent to the right edge on tablet 110 would be the landing zone.

Moreover, while the illustrated embodiment shows two horizontally adjacent displays, the system and methods described herein may also be applied in an analogous manner to two displays that are vertically adjacent, such that the top edge of one display abuts the lower edge of a second display.

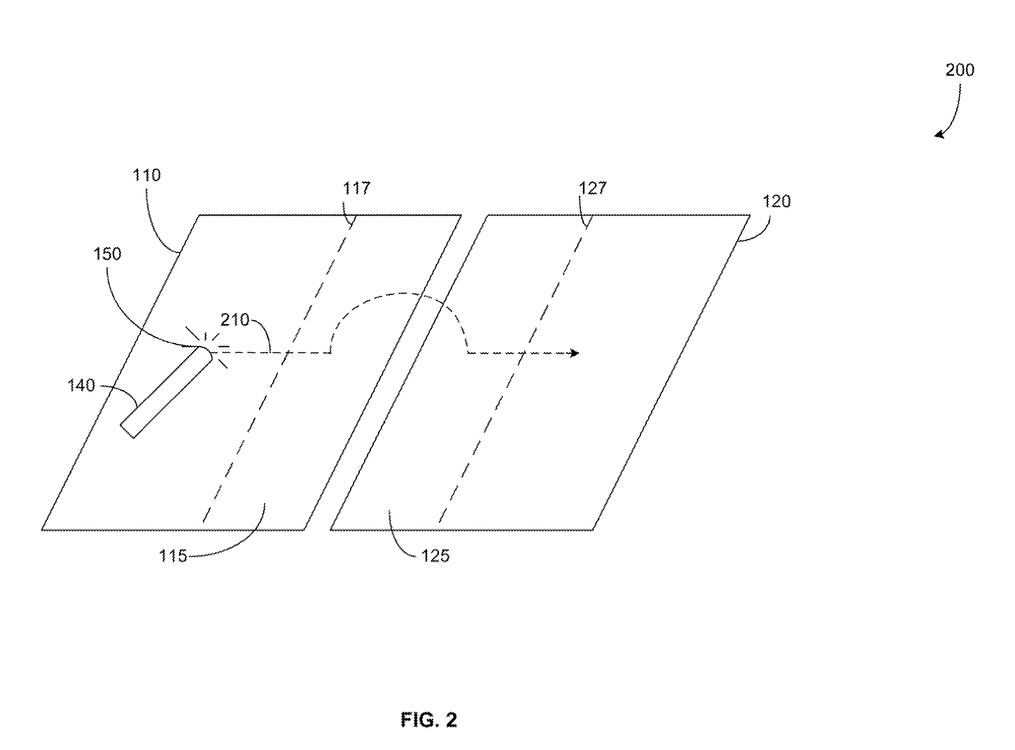

User interaction with touch displays such as tablets 110 and 120 is illustrated in FIG. 2, according to an embodiment. A user is applying a stylus 140 to tablet 110. The user may seek to perform a drag from tablet 110 to tablet 120. The path of the tip of stylus 140 is shown as path 210. The contact point 150 of stylus 140 may first approach lift zone 115. As this approach takes place, lift zone 115 may expand in proportion to the approach velocity of the contact point 150. The front 117 of lift zone 115 may therefore move away from the right edge of tablet 110 to an extent proportional to the approach speed. Contact point 150 may then cross front 117 of lift zone 115. The user may then lift the stylus 140 from the lift zone 115 and land stylus 140 on the surface of tablet 120. If the user intends to perform a drag that moves from tablet 110 to tablet 120, the user will likely make contact with tablet 120 in landing zone 125. In the illustrated embodiment, the front 127 of landing zone 125 may move away from the left edge of tablet 120, so as to expand the landing zone 125 at essentially the same rate and at the same time as the expansion of lift zone 115. If the user so desires, path 210 of the drag may continue beyond front 127 of landing zone 125.

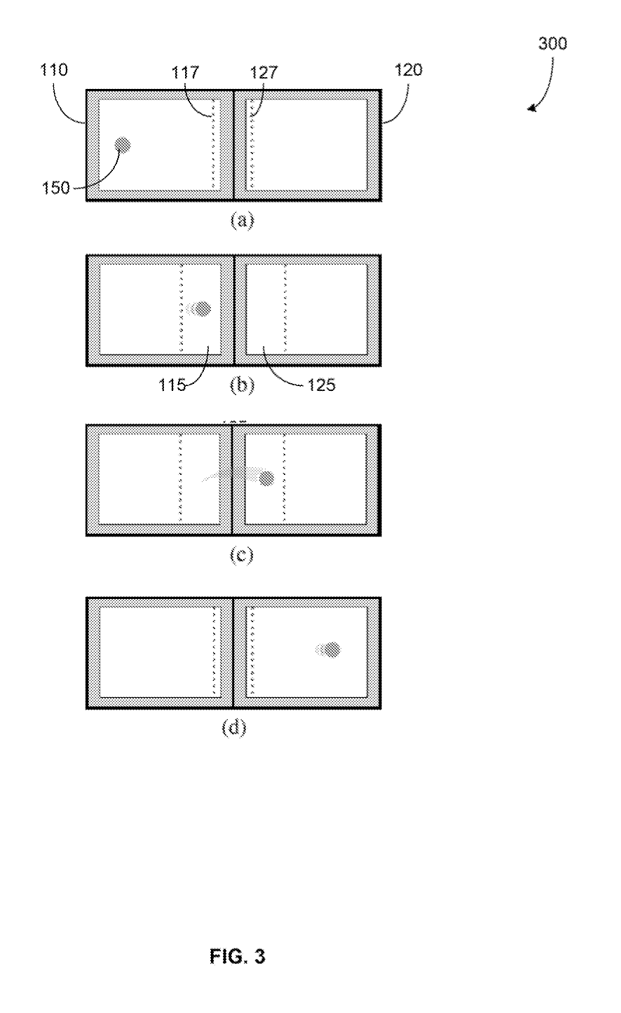

The expansion of a lift zone and a landing zone in response to a user movement is illustrated in FIG. 3, according to an embodiment. At time (a), the contact point 150 is shown on tablet 110 outside of lift zone 115. The contact point 150 may then move towards the right edge of tablet 110. The lift zone 115 may expand in an amount that is a function of the approach velocity of the contact point 150. In an embodiment, the lift zone 115 may expand in an amount that is proportional to the velocity of the contact point 150. At time (b), the contact point 150 may cross front 117 of lift zone 115. By now, the lift zone 115 has expanded in response to the movement of the contact point 150. At time (c), the contact point 150 may now be detected on tablet 120, in landing zone 125. At time (d), the contact point 150 may move past front 127 of landing zone 125. In the illustrated embodiment, the landing zone 125 and the lift zone 115 may contract after contact point 150 has moved to tablet 120.

In alternative embodiments, the lift zone 115 may expand as a different function of the velocity of the contact point 150. For example, the function by which the lift zone expansion and the contact point velocity are related may be non-linear; the function may be, for example, a square or an exponential function, and/or may entail scaling. These functions are intended as examples, and are not meant to be limiting.

In an embodiment, the lift zone 115 and landing zone 125 may have a minimum default size, as shown in FIG. 3 at (a) and (d). Therefore, in such an embodiment, if contact point 150 is not in motion, the lift zone 115 and landing zone 125 may have the minimum default size. Likewise, if contact point 150 has arrived in landing zone 125, then lift zone 115 and landing zone 125 may contract to this default size. In an embodiment, the default minimum lift and landing zones may extend 1 cm from each edge.

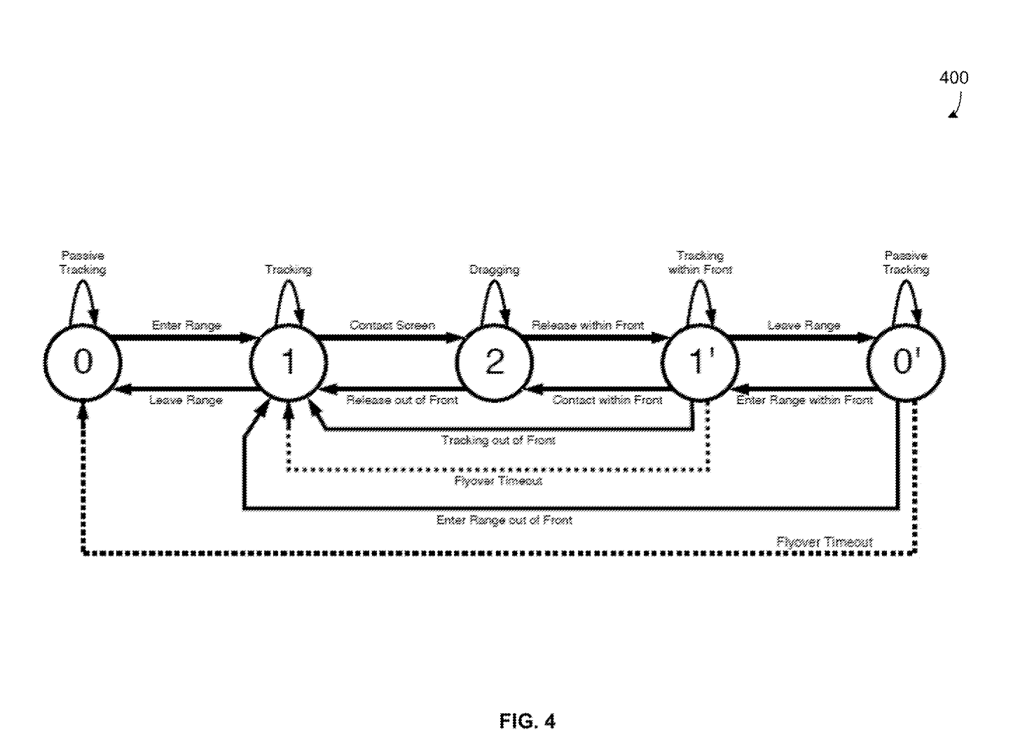

The processing for these operations may be illustrated as a state diagram, as shown in FIG. 4, according to an embodiment. State 0 represents the time when the stylus may be in the air but the display is not capable of sensing the stylus. State 1 may be entered when the stylus enters the sensing range of the display. State 2 may be entered when the stylus makes contact with the display, thus beginning a drag action. If it is determined that the user is completing a drag on the initial display, the system may transition back to state 1.

By lifting the stylus within the lift zone, the system may move from state 2 to state 1′. In state 1′ the stylus is no longer contacting the screen, but the underlying input hardware may still sense its position. Since the user is in the process of moving between screens, there may be no passing of any input events to the system. Therefore, the application software may not be aware of the stylus lift. The net effect is that the cursor may appear to freeze at the point of the lift.

If the stylus tracks away from the lifting or landing zones while in state 1′, the buffered lift event may be fired, and the system may transition to state 1. The transition from state 1′ to 1 may occur due to an internal timeout. The timeout may be required to deal with situations where a user drags an object inside the front but then hovers for a period of time without moving. This behavior could occur for example, when the user finishes a movement but is resting the pen above the screen.

As the drag between displays continues from state 1′, the stylus may move up and over between the displays. As such, the stylus may move out of the sensing range of the screen and the system may enter state 0′. As above, a timeout may cause the system to transition to state 0. If the stylus reenters tracking range outside of the front, the system may move to state 1. Finally, re-entering the tracking range inside the front may return to state 1′. To transition back to state 2 from state 1′ and finish the drag, the stylus may make contact with the screen within the landing zone before the timeout is triggered (i.e., before the timeout interval concludes).

After successfully making contact in the landing zone, a move event may be created from the coordinate where the user lifted (the position of the 2-to-1′ transition) to where contact is made again (the transition 1′-to-2). The net result from the application's perspective may be that the user momentarily stopped moving during the drag on one display and then resumed movement on the second display.

In both states 0′ and 1′, the “prime” may signify that any applications listening to the input stream still believe the input device to be frozen in state 2, while the digit (0 or 1) may signify the actual state of the underlying input device. Until the user continues the dragging action on the other side of the edge, or the system times out, any software receiving events may believe that the user has simply frozen in the middle of a dragging action.

While the process as presented above assumes the ability to sense a hover state, the technique may be implemented with a two state input device. The above process may be modified by moving states 0 and 0′ to states 1 and 1′ respectively. Ensuring that the visual representation of the cursor properly responds to the user may require the use of the hover events above. However, this would not be necessary in a two-state input system, such as a system that includes a resistive touchscreen that does not use an on-screen representation of the cursor.

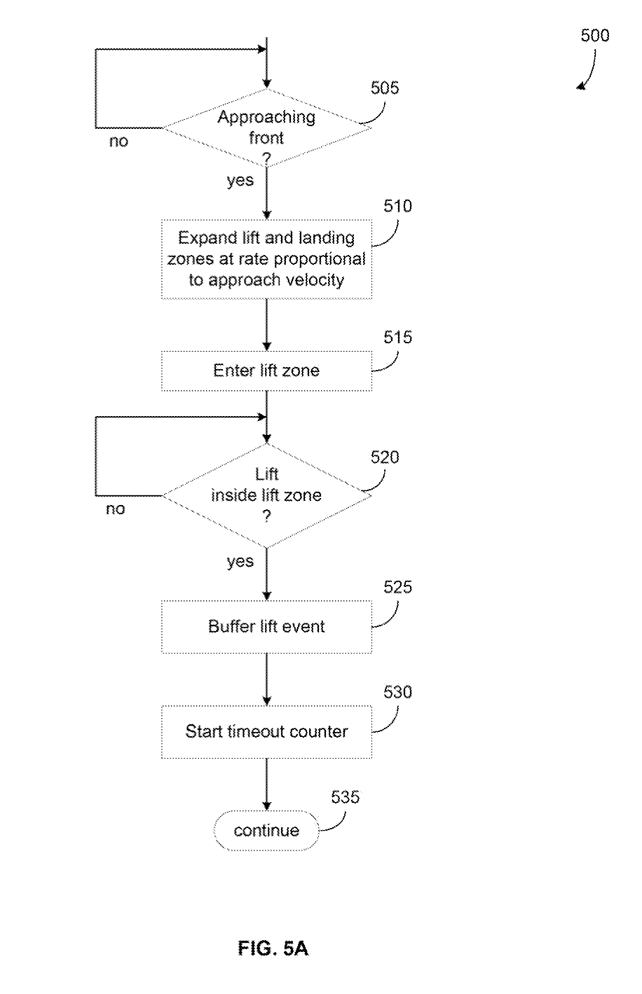

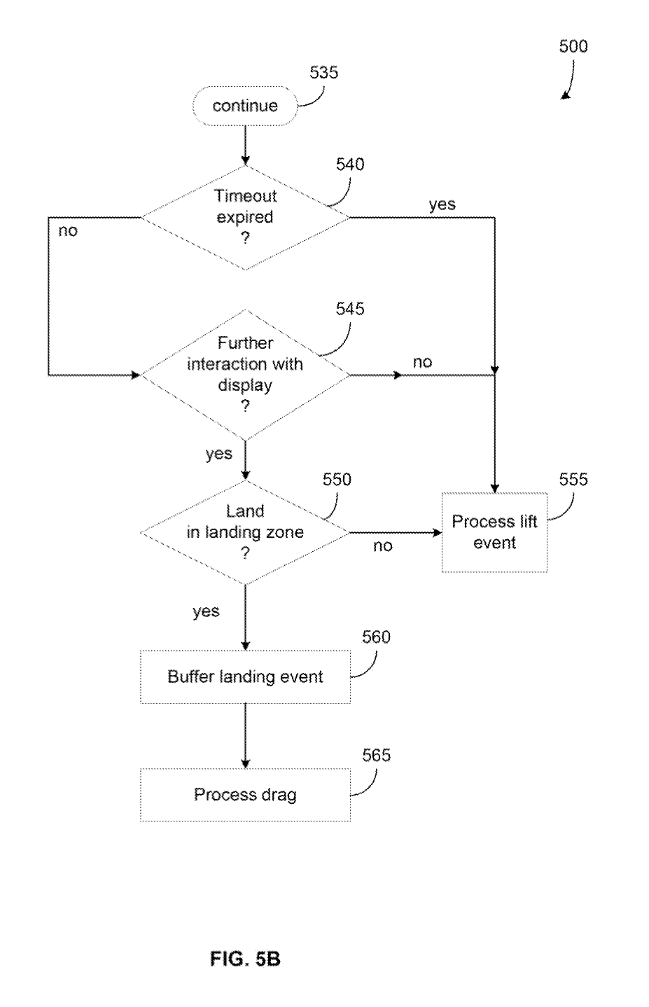

FIGS. 5A and 5B illustrate the processing of an embodiment from a process flow perspective. Referring to FIG. 5A, at 505 a determination may be made as to whether a contact point of a stylus is approaching the front of a lift zone. If so, then at 510, the lift zone and landing zone may expand at a rate proportional to the velocity of the approaching contact point. As noted above, in alternative embodiments, the lift zone may expand as a different function of the velocity of the contact point. For example, the function by which the lift zone expansion and the contact point velocity are related may be non-linear; the function may be, for example, a square or an exponential function, and/or may entail scaling. These functions are intended as examples, and are not meant to be limiting.

At 515, the contact point may enter the lift zone. At 520, a determination may be made as to whether a lift has been performed inside the lift zone. If so, then at 525 the lift event may be buffered and not otherwise processed. At 530, a timeout counter may be started.

Referring to FIG. 5B, at 540 a determination may be made as to whether the timeout counter has expired. If so, then the lift may be processed at 555. If not, then at 545 a determination may be made as to whether there has been additional interaction (i.e., contact) with the displays. If not, then at 555, the lift event (previously buffered) may be processed. If there has been additional interaction with the touch screens, then a determination may be made at 550 as to whether the stylus has landed in the landing zone. If so, then this contact (or landing event) may be buffered at 560 and not otherwise processed. If there has been no landing in the landing zone, then the lift event may be processed at 555. At 565, the system may process the drag as if the drag has continued from the point of the lift event to the point of the landing event, without the actual lift and landing events having been processed.

Methods and systems are disclosed herein with the aid of functional building blocks illustrating the functions, features, and relationships thereof. At least some of the boundaries of these functional building blocks have been arbitrarily defined herein for the convenience of the description. Alternate boundaries may be defined so long as the specified functions and relationships thereof are appropriately performed.

One or more features disclosed herein may be implemented in hardware, software, firmware, and combinations thereof, including discrete and integrated circuit logic, application specific integrated circuit (ASIC) logic, and microcontrollers, and may be implemented as part of a domain-specific integrated circuit package, or a combination of integrated circuit packages. The term software, as used herein, refers to a computer program product including a computer readable medium having computer program logic stored therein to cause a computer system to perform one or more features and/or combinations of features disclosed herein.

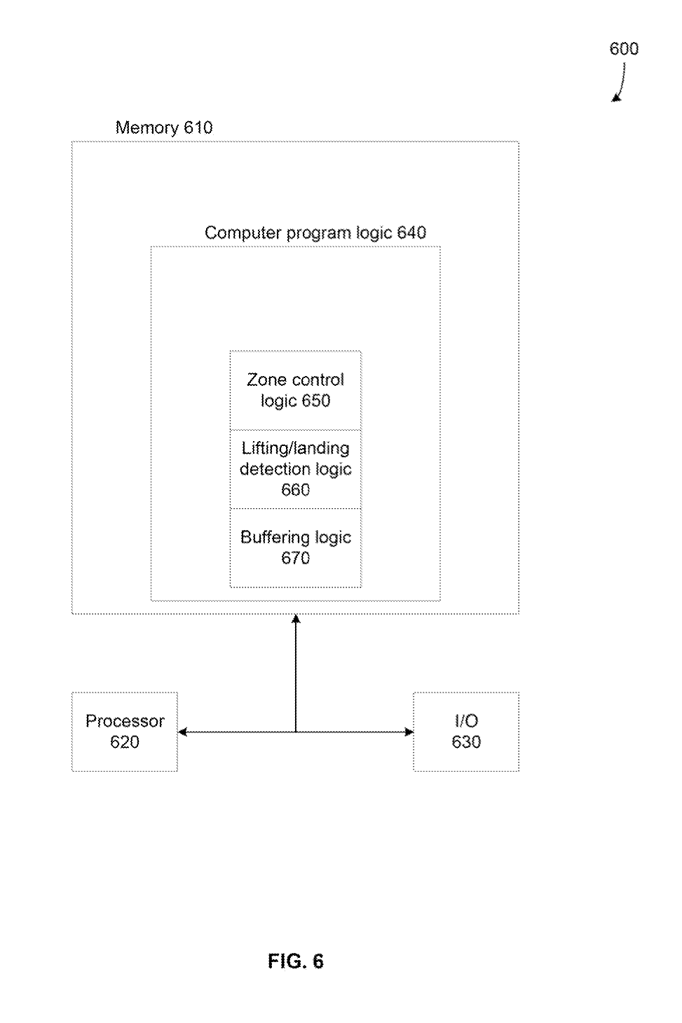

A software or firmware embodiment of the processing described above is illustrated in FIG. 6. System 600 may include a processor 620 and a body of memory 610. Memory may include one or more computer readable media that may store computer program logic 640. Memory 610 may be implemented as a hard disk and drive, a removable media such as a compact disk and drive, or read-only memory (ROM) or flash device(s), for example, or some combination thereof. Processor 620 and memory 610 may be in communication using any of several technologies known to one of ordinary skill in the art, such as a bus. Logic contained in memory 610 may be read and executed by processor 620. One or more I/O ports and/or I/O devices, shown collectively as I/O 630, may also be connected to processor 620 and memory 610.

Computer program logic 640 may include computer readable code that, when read and executed by processor 620, results in the processing described above with respect to FIGS. 4, 5a and 5b. In an embodiment; computer program logic 640 may include logic modules 650-670. Zone control logic 650 may be responsible for controlling the expansion and contraction of the landing and lift zones in response to stylus actions, as described above. Lifting/landing detection logic 660 may be responsible for detecting and processing lifting and lauding events, where the processing may depend on where and when the lift or landing event takes place on the display. Buffering logic 670 may be responsible for buffering lifting and landing events in the context of a drag operation across the two displays, and removing them from the buffer for processing as appropriate, as described above. In an embodiment, buffering logic 670 may be incorporated in lifting/landing detection logic 660. In alternative embodiments, additional logic modules may be used to implement the processing described above, or fewer modules may be used; moreover, alternate organizations of the processing logic, other than what is illustrated in FIG. 6, may be implemented.

While various embodiments are disclosed herein, it should be understood that they have been presented by way of example only, and not limitation. It will be apparent to persons skilled in the relevant art that various changes in form and detail may be made therein without departing from the spirit and scope of the methods and systems disclosed herein. Thus, the breadth and scope of the claims should not be limited by any of the exemplary embodiments disclosed herein.

What is claimed is:

1. A method, comprising:
on a first display, detecting a contact point approaching a lift zone that is oriented parallel to an edge of the first touch display and that extends from the edge of the first touch display to a front of the lift zone;
expanding the lift zone to an extent proportional to the velocity of the approach;
detecting entry of the contact point into the lift zone;
detecting a lift event at the contact point in the lift zone;
buffering the lift event;
on a second touch display, detecting a landing event at a second display adjacent to the first display, where the landing event is detected in a landing zone that is oriented parallel to an edge of the second display and to the lift zone, and that extends from the edge of the second display to a front of the landing zone;
buffering the lauding event; and
processing a drag event from the first display to the second display.

2. The method of claim 1, wherein the lift zone has a default minimum width prior to expansion.

3. The method of claim 1; further comprising:
expanding the landing zone to an extent proportional to the velocity of the approach,
performed after said detecting of the control point on the first touch display and
before said detecting of the control point on the second touch display.

4. The method of claim 3, wherein the landing zone has a default minimum width prior to expansion.

5. The method of claim 1, further comprising:
beginning a timeout interval after buffering the lift event, wherein
if there is no further interaction with the displays during the interval, then processing the lift event;
if there is further interaction with the displays outside the landing zone, then processing the lift event; and
if there is further interaction with the display inside the landing zone, then detecting the control point in the landing zone and processing the drag event.

6. A system, comprising:
a processor; and
a memory in communication with said processor, wherein the memory stores a plurality of processing instructions configured to direct said processor to
detect, at a first display, a contact point approaching a lift zone that is oriented parallel to an edge of the first display and that extends from the edge of the first display to a front of the lift zone;
expand the lift zone to an extent proportional to the velocity of the approach;
detecting entry of the contact point into the lift zone;
detect a lift event at the contact point in the lift zone;
buffer the lift event;
at a second display, detect a landing event at a second display adjacent to the first display, where the lauding event is detected in a landing zone that is oriented parallel to an edge of the second display and parallel to the lift zone, and that extends from the edge of the second display to a front of the landing zone;
buffer the landing event; and
process a drag event from the first display to the second display.

7. The system of claim 6, wherein the lift zone has a default minimum width prior to expansion.

8. The system of claim 6, wherein said processing instructions are further configured to direct said processor to:
expand the landing zone to an extent proportional to the velocity of the approach,
performed after said detecting of the control point on the first display and
before said detecting of the control point on the second display.

9. The system of claim 8, wherein the landing zone has a default minimum width prior to expansion.

10. The system of claim 6, wherein said processing instructions are further configured to direct said processor to:
begin a timeout interval after buffering the lift event, wherein
if there is no further interaction with the displays during the interval, then the lift event is processed;
if there is further interaction with the displays outside the landing zone, then the lift event is processed; and
if there is further interaction with the display inside the landing zone, then the control point in the landing zone is detected and the drag event is processed.

11. A computer program product including a non-transitory computer readable medium having computer program logic stored therein, the computer program logic including:
logic to cause a processor to detect, at a first display, a contact point approaching a lift zone that is oriented parallel to an edge of the first display and that extends from the edge of the first display to a front of the lift zone;
logic to cause the processor to expand the lift zone to an extent proportional to the velocity of the approach;
logic to cause the processor to detect entry of the contact point into the lift zone;
logic to cause the processor to detect a lift event at the contact point in the lift zone;
logic to cause the processor to buffer the lift event;
logic to cause the processor to detect, on a second display adjacent to the first display, a landing event on the second display, where the landing event is detected in a landing zone that is oriented parallel to an edge of the second display and to the lift zone and that extends from the edge of the second display to a front of the landing zone;
logic to cause the processor to buffer the landing event; and
logic to cause the processor to process a drag event from the first display to the second display.

12. The computer program product of claim 11, wherein the lift zone has a default minimum width prior to expansion.

13. The computer program product of claim 11, the computer program logic further comprising:
logic to cause the processor to expand the landing zone to an extent proportional to the velocity of the approach,
performed after the detecting of the control point on the first touch display and
before the detecting of the control point on the second touch display.

14. The computer program product of claim 13, wherein the landing zone has a default minimum width prior to expansion.

15. The computer program product of claim 11, the computer program logic further comprising:
logic to cause the processor to begin a timeout interval after buffering the lift event, wherein
if there is no further interaction with the displays during the interval, then the lift event is processed;
if there is further interaction with the displays outside the landing zone, then the lift event is processed; and
if there is further interaction with the display inside the landing zone, then the control point in the landing zone is detected and the drag event is processed.
